(19) United States
(12) Patent Application Publication
(10) Pub. No.: US 2025/0065483 A1
(43) Pub. Date: Feb. 27, 2025

(54) GROUND PIERCING APPARATUS

(71) Applicant: Stephen LaFontaine, Chino, CA (US)

(72) Inventor: Stephen LaFontaine, Chino, CA (US)

(21) Appl. No.: 18/452,560

(22) Filed: Aug. 21, 2023

(51) Int. Cl. B25D 17/28

(52) U.S. Cl. CPC B25D 17/28; B25D 2222/72

(57) ABSTRACT

A ground piercing apparatus 100 for creating a hole through the ground. In at least one embodiment, the apparatus includes a carriage 128 capable of receiving a tool 116 that can make a hole through the ground, a leverage sleeve 110 or bar connected to the carriage 128 and one or more leverage rails 102 having more than one opening 136.

### FIELD OF THE INVENTION

The present disclosure generally relates to an apparatus that is used to make one or more holes through the ground. More specifically, the present disclosure is related to a ground piercing portable apparatus that can be used by a person to hold, align, guide and propel a tool, with or without power, (e.g., projectile, drill, electric or pneumatic hammer or jackhammer) to create one or more holes in various soil conditions through various materials, including difficult-to-penetrate materials, such as rocks, concrete, asphalt, and plant roots to place various construction objects, such as cable, pipe and conduit, under the ground or within a pre-constructed object.

### BACKGROUND

Often times, during construction, one must place various construction objects, including but not limited to, cable, pipe, conduit, etc. under the ground or within a pre-constructed object. Accordingly, a hole or opening must be created to allow the construction object to be placed in through different materials having different densities (soil, asphalt, concrete, rock, tree, and other plant roots). Oftentimes, the hole needs to be made through difficult to penetrate material/s (e.g., rocks, concrete, asphalt, plant roots), which requires the drilling, fracturing, or piercing through and/or breaking difficult to penetrate materials. Sometimes, the person that needs to create a hole and place the construction object under pavement does not know whether or not there is an object to penetrate, such as large rocks, chunks of concrete, asphalt, bricks, tree roots, gravel, etc., in the area where the construction object needs to be placed. Accordingly, oftentimes, the person placing the construction object would either entirely remove the pavement or use tools like a hammer, jackhammer, sledgehammer, ground piercing bars, shovels, ground piercing apparatuses such as pneumatic “missiles” or “torpedoes” or others using erosion techniques incorporating pipe and water and/or other tools to open a hole through the material where they need to place (or insert) the construction object.

### SUMMARY

In one embodiment of the present invention, a portable ground piercing apparatus configured to pierce a horizontal hole through the ground, includes a carriage capable of receiving a tool, with or without power, a leverage sleeve or bar and one or more leverage rails having more than one opening.

In another embodiment of the present invention, a portable ground piercing apparatus configured to pierce a horizontal hole through the ground, includes a carriage capable of receiving a tool, with or without power, a leverage sleeve or bar, one or more means of securing the carriage or leverage sleeve or bar to the one or more leverage rails having more than one opening, a carriage configured to travel at least backward and forward on a one or more leverage rails, and the apparatus holds, aligns, guides, and propels a tool, with or without power, forward or reverse.

In another embodiment of the present invention, the apparatus comprises of one or more means of securing the carriage and the leverage sleeve or bar to the leverage rail, wherein the one or more means is a leverage hook.

In another embodiment of the present invention, the carriage is configured to travel at least backward and forward on one or more leverage rails.

In another embodiment of the present invention, the apparatus provides various benefits and advantages over prior methods depending on the configuration.

In another embodiment of the present invention, the apparatus holds, aligns, guides, and propels a tool, with or without power, such as a projectile, drill, electric or pneumatic hammer or jackhammer forward.

In another embodiment of the present invention, the apparatus allows a single person to create a hole in the exact location, alignment and direction that the person operating the apparatus desires in various soil conditions through various materials, including difficult-to-penetrate materials, such as rocks, concrete, asphalt, and plant roots to place various construction objects (e.g., cable, pipe, conduit) under the ground or within a pre-constructed object using additional leverage, force, and alignment that the apparatus provides.

In another embodiment of the present invention, the apparatus eliminates the need to swing a sledgehammer or other tool to hit the projectile (e.g., impact cap) to drive the projectile through the material the person is making a hole in.

In another embodiment of the present invention, the apparatus having a carriage capable of receiving a tool, with or without power, is capable of traveling backwards, without removing and turning the carriage around, and extracting construction materials out of a hole.

In yet another embodiment of the present invention, the apparatus is portable and can easily be carried. Furthermore, it is compact and can easily fit in a small truck or car making transportation easy.

These and other advantages will be apparent from the present application of the embodiments described herein.

The preceding is a simplified summary to provide an understanding of some embodiments of the present invention. This summary is neither an extensive nor exhaustive overview of the present invention and its various embodiments. The summary presents selected concepts of the embodiments of the present invention in a simplified form as an introduction to the more detailed description presented below. As will be appreciated, other embodiments of the present invention are possible utilizing, alone or in combination, one or more of the features set forth above or described in detail below.

### BRIEF DESCRIPTION OF DRAWINGS

The drawings disclose illustrative embodiments and represent graphical summaries of the data explained and described herein. They do not set forth all embodiments. Other embodiments may be used in addition or instead. Details that may be apparent or unnecessary may be omitted to save space or for more effective illustration. Conversely, some embodiments may be practiced without all of the details that are disclosed. When the same numeral appears in different drawings, it is intended to refer to the same or like components or steps.

The above-mentioned features and objects of the present disclosure will become more apparent with reference to the following description taken in conjunction with the accompanying drawings and in which:

FIG. 1 depicts a top, left, front perspective view of the apparatus including a power tool, in accordance to at least one embodiment of the present invention.

FIG. 2 depicts a top, left, front perspective view of the apparatus, in accordance to at least one embodiment of the present invention.

FIG. 3 depicts a bottom, left, front view of the apparatus, in accordance to at least one embodiment of the present invention.

FIG. 4 depicts a front elevational view of the apparatus, in accordance to at least one embodiment of the present invention.

FIG. 5 depicts a rear elevational view of the apparatus, in accordance to at least one embodiment of the present invention.

FIG. 6 depicts a top elevational view of the apparatus, in accordance to at least one embodiment of the present invention.

FIG. 7 depicts a bottom elevational view of the apparatus, in accordance to at least one embodiment of the present invention.

FIG. 8 depicts a left elevational view of the apparatus, in accordance to at least one embodiment of the present invention.

FIG. 9 depicts a right elevational view of the apparatus, in accordance to at least one embodiment of the present invention.

FIG. 10 depicts a top, left, front perspective exploded view of the apparatus, in accordance to at least one embodiment of the present invention.

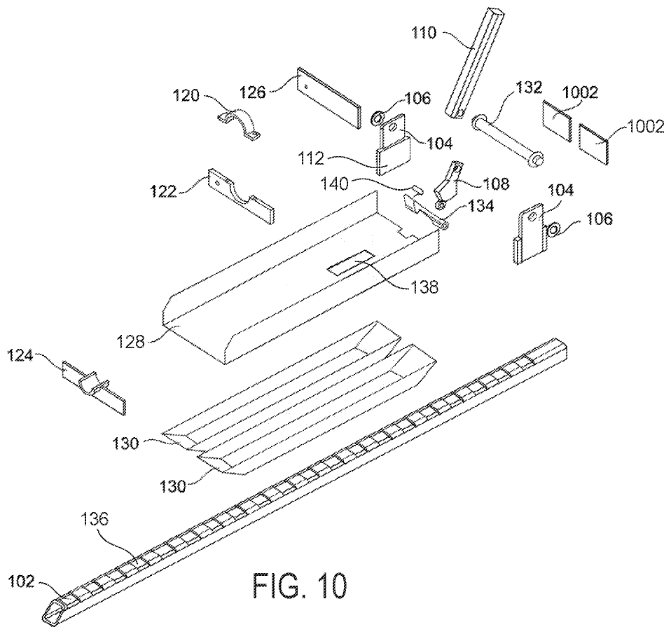

FIG. 11 depicts a bottom, left, front perspective exploded view of the portable ground piercing apparatus, in accordance to at least one embodiment of the present invention.

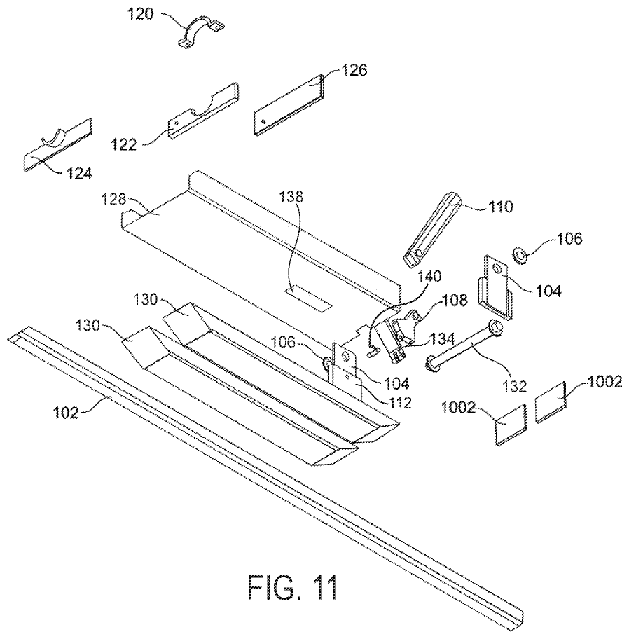

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). Similarly, the words “include”, “including”, and “includes” mean including but not limited to. To facilitate understanding, like reference numerals have been used, where possible, to designate like elements common to the figures. Optional portions of the figures may be illustrated using dashed or dotted lines, unless the context of usage indicates otherwise

### DETAILED DESCRIPTION

The present disclosure is not limited to the illustrated embodiments described herein but also includes a variety of modifications and embodiments thereto. Therefore, the present disclosure should be seen as illustrative and not limiting. While the invention is susceptible to various modifications and alternative constructions, it should be understood, that there is no intention to limit the invention to the specific form or specific embodiment disclosed herein, but, on the contrary, the invention is to cover all modifications, alternative constructions, and equivalents falling within the spirit and scope of the invention as defined in the claims.

As used herein, the singular forms “a”, “an”, and “the” designate both the singular and the plural, unless expressly stated to designate the singular only.

In one embodiment of the present invention disclosed herein, the apparatus can be used to assist in making a hole through the ground. In at least one embodiment, the one or more holes can be made horizontally under pavement, through the substrate, beginning at the desired entrance point, and then exiting on the other side of the pavement, at the desired exit point to gain access under pavement from one point to another.

In another embodiment of the present invention disclosed herein, the apparatus has the capability of installing a construction object (such as a pipe or conduit) in a particular location by moving the carriage, that includes a tool, with or without power, backwards and pulling the construction object into a particular desired location.

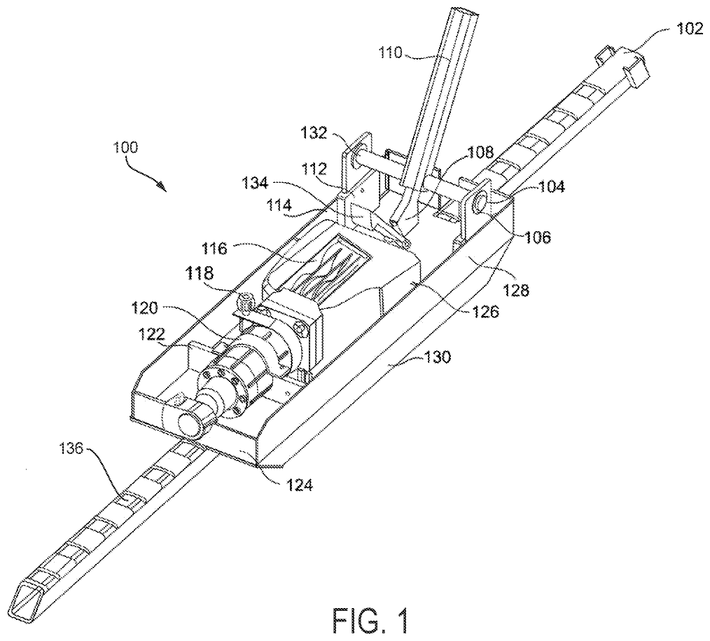

FIG. 1 depicts a portable ground piercing apparatus 100 used to drill, fracture, or pierce through and/or break various materials, including difficult-to-penetrate materials such as rocks, concrete, asphalt, and plant roots to place various construction objects, including but not limited to, cable, pipe, conduit, etc. under the ground or within a preconstructed object. The apparatus 100 may perform the ground penetration action using a tool, with or without power, which is being mounted upon the apparatus 100. The apparatus 100 may be used and operated by one person, making the job of making the desired hole in various soil conditions through the various materials, including difficult-to-penetrate materials such as rocks, concrete, asphalt, and plant roots, and placing the construction object much easier, faster, and capable of being completed by one person. The apparatus 100 is portable and can easily be carried, and it is compact and can easily fit in a small truck or car making transportation easy.

Further, the apparatus 100 comprises a carriage 128, and one or more leverage rails 102, according to embodiments of the present invention. The carriage 128 may be configured to travel backward and forward upon one or more leverage rails 102.

The carriage 128 may be made up of a material, selected from, but not limited to, a wood, a fiberglass, a chromed steel, a steel, a stainless steel, a plastic, a carbon fiber, an aluminum, a leather, a Poly Vinyl Chloride (PVC), a hardened plastic, and so forth. Embodiments of the present invention are intended to include or otherwise cover any type of material. The carriage 128 may be of different shapes and sizes, such as, but not limited to, a cuboid, a cube, a cylindrical, a hexagonal, a square, a rectangular, and so forth. Embodiments of the present invention are intended to include or otherwise cover any of the shapes and size for the carriage 128.

Similarly, the leverage rails 102 may be made up of a material, selected from, but not limited to, a wood, a fiberglass, a chromed steel, a steel, a stainless steel, a plastic, a carbon fiber, an aluminum, a leather, a Poly Vinyl Chloride (PVC), a hardened plastic, and so forth. Embodiments of the present invention are intended to include or otherwise cover any type of material. According to embodiments of the present invention, the leverage rails 102 may be of different shapes and sizes, such as, but not limited to, cuboids, a cube, a cylindrical, a hexagonal, a square, a rectangular, and so forth. Embodiments of the present invention are intended to include or otherwise cover any of the shapes and the size for all the components of the apparatus shown herein. In at least one embodiment of the present invention, the leverage rail 102 may be one in number. In another embodiment of the present invention, the leverage rail 102 may be two or more in number.

The present invention provides an apparatus that holds, aligns, guides, and propels a ground tool, with or without power (e.g., projectile, drill, electric or pneumatic hammer or jackhammer drill) forward. The apparatus of the present invention, together with a tool, such as a jackhammer, is driven or thrust through the ground, thereby creating the desired hole in the desired location so that the construction object (e.g., pipe, conduit, wire or other objects) can be placed into said hole. Among other things, the present invention allows a single person to create a hole in the exact location, alignment, and direction that the person creating the hole desires using additional leverage, force, and alignment that the apparatus provides. Among other things, the present invention also allows the person using the apparatus, propelling and driving the ground piercing tool, to go through various materials, including difficult-to-penetrate materials using, at least in part, the power or forward thrust of leverage created by the apparatus holding the tool, which means significantly less labor is required to complete the job. The apparatus shown and described herein can be used and operated by one person, making the job of forming the desired hole through various materials, including dense debris laden soil, and placing the construction object into the hole much easier, faster, and capable of being completed by one person.

The use of the invention disclosed herein eliminates the need to swing a sledgehammer or other tool with a certain amount of accuracy to hit the projectile ground piercing tool or device (e.g., impact cap) to drive the projectile through the material the person is making a hole in. In one embodiment of the apparatus shown and described herein incorporates both the impact forces of the impact tool it's holding (e.g., jackhammer) at a much higher frequency than a sledgehammer, while including the augmented forward thrust and leverage created by the leverage apparatus, which incorporates the combined forces and interactions between the leverage rail, the leverage hook, the fulcrum point of the axel connecting the leverage sleeve to the leverage hook and the carriage and the leverage sleeve or bar being operated by the worker, thereby engaging the entire leverage apparatus which in turn creates an augmented forward thrust to push or propel the jackhammer forward which in turn will drive the ground piercing tool and apparatus through the ground, thus opening the desired hole.

Accordingly, among other things, the apparatus shown and described herein dramatically reduces the effort needed to make the hole or opening in or under virtually any material or surface. Additionally, the apparatus shown and described herein is compact and can easily fit in a small truck or car. Another benefit and feature of the apparatus shown and described herein are that it is able to operate in reverse without having to remove the carriage from the leverage rail of the apparatus and turn it around, which provides at least two benefits. First, operating the apparatus in reverse makes the projectile that is creating the hole much easier to extract, as oftentimes debris from whatever the projectile is boring through gets in the way of removing the projectile. Second, in certain applications where the construction object that you want to place (e.g., pipe) is connected to the projectile creating the hole, the pipe or conduit can be pulled back through the desired hole at the same time that projectile is being extracted.

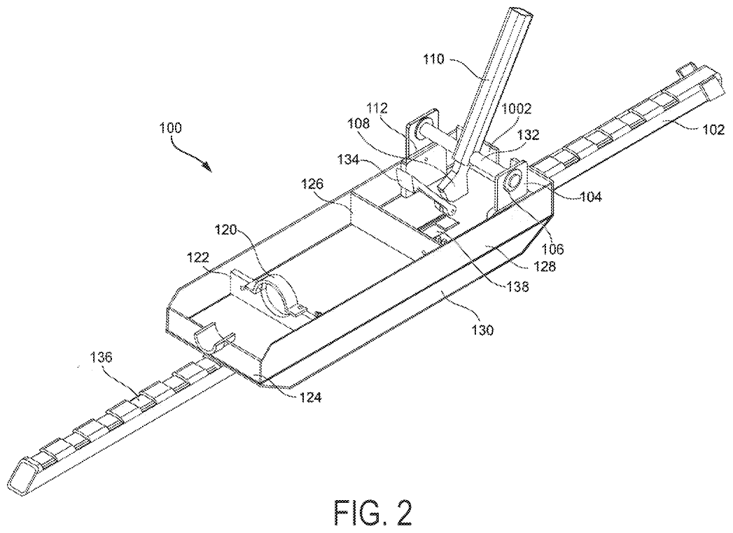

FIG. 2 depicts the portable ground piercing apparatus 100, according to embodiments of the present invention. The carriage 128 may be designed in a manner that it receives a power tool 116 shown in FIG. 1. The power tool 116 shown in FIG. 1 may be, but is not limited to, an electric or pneumatic jack hammer, or other device capable of creating or generating impact forces. Embodiments of the present invention are intended to include or otherwise cover any type of ground piercing tool, with or without power. In one embodiment, the tool 116 shown in FIG. 1, receives power and can be connected to a power source such as an extension cord from an electrical outlet or a portable generator.

According to at least some of the embodiments of the present invention, the power tool 116 shown in FIG. 1 is installed and attached. to the carriage 128. The head of the power tool 116 shown in FIG. 1 is placed in between a first support 124, a second support 122, and a third support 126. The first support 124 has a slot in its middle of the semicircular part, which is used to secure one end of the extraction chain to the carriage or body while the other end of the extraction chain is connected to the ground piercing apparatus when operating the apparatus 100 in reverse to remove the shafts and or pull in the intended pipe, conduit or construction material. The neck of the power tool 116 shown in FIG. 1 is connected to the second support 122 which uses a clamp 120 and two screws to secure the connection. In at least one embodiment, the carriage 128 holding the power tool 116 slides over the top of the leverage rail 102.

Further, the carriage 128 is connected to a leverage mechanism. The leverage mechanism, situated in the carriage 128 behind the area of the carriage that houses the power tool 116, has the capability and purpose of increasing or augmenting the forward thrust force of the carriage. The leverage mechanism includes a leverage sleeve 110, inserted into a leverage sleeve end 108, which pivots on an axle 132 that passes between, and the leverage sleeve end 108 is attached to a leverage hook 134 at the opposite side of the axle 132. The axle 132 is situated in such a way that as forces are applied by and to the leverage sleeve 110, that these forces are greatly increased on the opposite side of the axle 132 and in turn transfer to the leverage hook 134.

In at least one embodiment, the axle 132 and the leverage sleeve 110 is connected to the carriage 128 by the axle supports 104 which are slid into two upright channels 112 and bolted into place. Next, a leverage bar is inserted into the leverage sleeve 110. In at least one embodiment, the compression point can be threaded onto a 1st shaft and the impact cap which can be inserted into the female end of the same shaft. In at least one embodiment of the invention, the shaft and compression point can be set into the ground at the penetration point and this embodiment present invention can be pulled into position with the impact cap being inserted into the jackhammer or other power tool adapter, which is connected to the steel of the power tool 116.

In another embodiment of the present invention, when the power tool 116 is turned on, the motor of the power tool 116 will turn on but it will not produce impact forces until a force is applied to the end of the power tool 116 by pushing the leverage sleeve 110 or bar forward and moving the carriage. As the power tool 116 is thrusted forward, it encounters resistance from the apparatus 100 that it is connected to and, by moving the leverage sleeve or bar 110 forward, the carriage within the apparatus will move forward and force the ground piercing power tool 116 to break through various difficult-to-penetrate materials such as soil, rocks, concrete, asphalt, and plant roots.

In at least one embodiment of the present invention, the leverage rail 102 is anchored to the ground with steel stakes at the front and rear ends of the rail so the rail is fixed and immovable. In at least another embodiment of the present invention, there are one or more openings on each end of the rail through which a stake or other attachment means can be driven or inserted. In at least another embodiment of the present invention, the leverage rail 102 is anchored to the ground with one stake in the front, that is driven into the ground so that the final elevation of the top of the stake will be below the top elevation of the leverage rail 102 and one stake in the rear of the leverage rail and the final elevation of the top of the stake will be higher than the top of the rail so the leverage rail 102 remains stationary. In at least one embodiment of the present invention, the carriage 128 holds the tool 116 and slides over the top of the leverage rail 102 and the carriage 128 further comprises side channels 130. According to at least some of the embodiments of the present invention, the carriage 128 rests upon the leverage rail 102 and the side channels 130 straddle the fixed leverage rail 102 which serves as a guide, maintaining both the carriage's elevation and trajectory, keeping it from wandering from side to side. The leverage rail 102 also provides leverage anchor points, which are actual openings 136 along the top of the rails 102 into which the leverage hook 134, drops into through an opening 138 in the carriage 128, will drop. In at least one embodiment, the side channels 130 are beveled on each end to ensure the carriage can move across uneven terrain and as the carriage 128 progresses forward, the leverage hook 134 drops sequentially into and thus engages these openings 136 in the fixed leverage rail 102. In at least one embodiment, as the leverage hook 134 engages with the leverage rail 102, a fixed anchor point is established. In at least one embodiment, the leverage mechanism is connected to or one with the carriage 128, which is holding the power tool 116, is set and ready to be maneuvered in a forward direction. In at least one embodiment, as the leverage sleeve 110 is pushed forward by the operator, the forward thrust ratio is increased by the leverage mechanism of the present invention.

In at least one embodiment, the leverage sleeve 110 where the leverage sleeve end 108 is inserted, needs to be maneuvered in such a manner as to allow the leverage hook 134 of the present invention to engage the opening 136 in the leverage rail 102 that is anchored to the bottom of the trench. The leverage hook 134 is connected to the leverage sleeve 110 by the leverage sleeve end 108. The leverage bar sleeve 110 and the leverage sleeve end 108 are intersected by and attached to the axle 132 which is mounted through two axle supports 104, and secured by two washers 106 on each side of the two axle supports 104. The axle supports 104 slots into two upright channels 112 on the carriage 128 and is bolted in place.

In at least one embodiment, the leverage hook 134 is used to connect the carriage 128 to the leverage rail 102 which serves as a stationary anchor point for the leverage hook 134 to engage allowing the carriage 128, which the hook 134 is connected to, to slide forward over the top of the rail 104. At the end of the forward stroke with the leverage sleeve, the leverage sleeve 110 and bar are cocked backward until the leverage hook 134 is thrust forward and in a ratcheting motion, lifts or deflects itself up and out of the hole sliding forward until it drops into the next opening 136 of the leverage rail 102. In some embodiments, the opening serves as the new anchor point for the leverage hook to engage as the forward thrust is again applied to the leverage bar shoving the present invention forward again. This is repeatable until the end of the leverage rail 102 is reached. Since the axle of the leverage apparatus is connected to the carriage 128 of the present invention, it will simultaneously thrust the power tool 116 and the present invention forward driving the ground piercing apparatus into the ground until the impact cap seats against the soil and cannot proceed any further. At this point, the leverage hook 134 is disengaged from the leverage rail 102 and can be held in place by magnets inserted into holes in the leverage sleeve end 108. The entire carriage 128 is then maneuvered forward or backward, using the leverage sleeve as a handle.

In at least one embodiment, a fulcrum point is established close to the end of the leverage sleeve 110. The fulcrum point is at the point of the axle 132 of the carriage. The leverage sleeve 110 is connected to this axle 132 and allows the leverage sleeve 110 to hinge at this fulcrum point. Two washers 106 are placed on both ends of the axle 132 where it connects to the axle supports 104 to secure the pieces together while maintaining the maneuverability of the leverage sleeve 110. This fulcrum point and axle 132 allows the leverage sleeve 110 and leverage sleeve end 108 to travel in a forward and reverse manner. As the leverage sleeve 110 is pushed forward, the carriage, which it is a part of, is simultaneously moved in a forward direction. At the end of the forward stroke of the leverage sleeve 110, the carriage stops, and the leverage sleeve 110 is pulled backward in the reverse direction which then moves the leverage hook 134 forward. There is a bevel at the front of the leverage hook 134, which wedges against the side of the opening in the leverage rail 102 and, as a foreword force is applied to the leverage hook 134, the leverage hook disengages from the opening 136 or lifts the leverage hook 134 out of the opening 136 so that it can slide over the top of the small section of the leverage rail 102, that separates the openings 136 until it reaches the next opening 136. When it reaches the next opening 136, it drops into it using gravitational forces. Once the leverage hook 134 of the carriage engages the leverage rail 102, then continued forward forces may be applied to the leverage sleeve 110 by the operator which will in turn thrust the present invention and power tool 116 forward until the end of the stroke with the leverage sleeve 110 is reached again and the process is repeated.

In another embodiment, when leverage is not used to move the position of the carriage 128, its position can be adjusted by removing the leverage hook 134 from the leverage rail 102 and resting the leverage hook 134 onto the support plate 126 or attaching it to one or more magnets mounted into the leverage sleeve end 108. The main body or carriage 128 can now move freely along leverage rail 102 until in the desired position. Once in position, the leverage hook 134 can be returned to its position by contacting the leverage rail 102. The entire leverage mechanism can also be removed from the carriage 128 by unbolting and sliding the axle supports 104 out of the upright channels 112 attached to the carriage 128. This makes transportation and storage of the present invention easier when not in use.

In at least one embodiment, the present invention is configured to work in reverse without removing the carriage 128 and turning it around in the opposite direction. The leverage hook 134 can be detached by removing the half-inch retaining pin 140 that connects the leverage hook 134 to the leverage sleeve end 108, rotated 180°, realign the holes in the hooks with the holes in the leverage sleeve end 108 and inserting the retaining pin 140. Engage the leverage hook 134 into an opening of the leverage rail 136, and now the leverage sleeve 110 and leverage sleeve end 108 may be operated in the same manner as before until the leverage sleeve 110 reaches the end of the stroke. Then, the leverage sleeve 110 is cocked or pulled backward, which in turn moves the leverage hook 134 up and out of the opening 136 sliding across the top solid portion of the leverage rail 102 until it drops into the next hole. The same process continues which will advance the carriage in the reverse direction. As the power tool 116 is removed from the carriage 128 there is a notch cut into the first support 124. This notch will grab the extraction chain which is connected to a shaft so that as the carriage advances in the reverse direction it will pull the shaft out of the hole and if needed will simultaneously pull in any conduit or pipe that is attached to the end of the shaft.

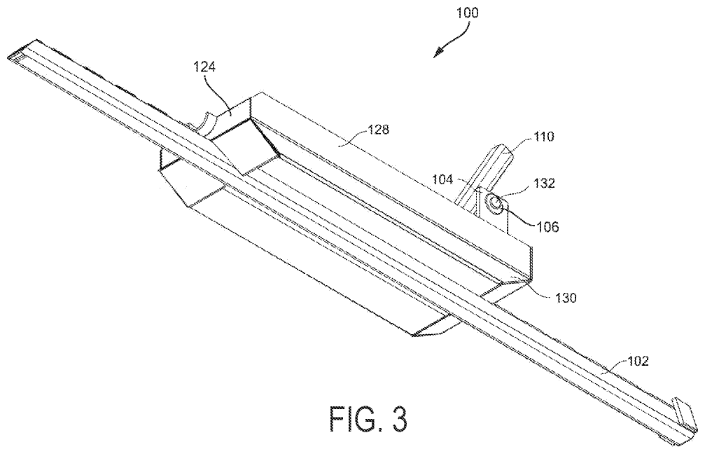

FIG. 3 depicts a bottom perspective view of the present invention 100. The carriage 128 sits atop the leverage rail 102 with a side channel 130 on either side. The side channels 130 are beveled to help the carriage move over uneven terrain and prevent the carriage from drifting side to side. The leverage rail 102 is firmly affixed to the ground with stakes and has a hole in the front bottom for a steak to be inserted through and another opening or brackets at the rear for additional steaks.

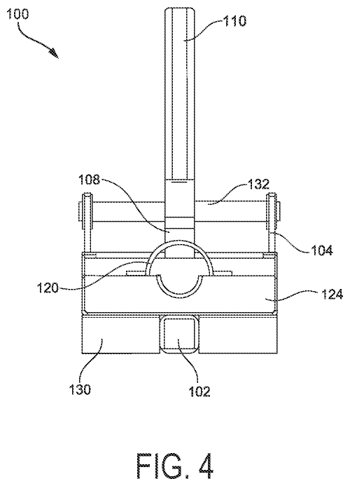

FIG. 4 depicts a front view of the portable ground piercing apparatus 100. The carriage 128 at the front has the first support 124 attached, which has a semi-circle cutout for holding the head of the power tool 116 and a notch for holding an extraction chain. Behind the first support 124, the second support 122 is present. The second support 122 along with the clamp 120 is used to hold the power tool 116 in place while the invention is being operated. The clamp 120 is screwed into the second support 122. Further, the third support 126 is attached to the carriage 128 behind the second support 122 and is placed such that the motor and controls of a power tool 116 fit in the empty space and still be accessed by the operator. Furthermore, the carriage 128 has a back plate 1002. The back plate 1002 is made of two separate plates with space or opening so the leverage sleeve 110, leverage sleeve end 108, and leverage hook 134, can pass freely between them.

Further, the leverage mechanism slots into the two upright channels 112 at the side back of the carriage 128 and are bolted in place when in use. The carriage 128 has a hole directly behind the third support 126 at the bottom surface, which allows the leverage hook 134 to go through the hole 138 and engage with the leverage rail 102. The leverage rail 102 contains evenly spaced openings 136 for the leverage hook 134 to engage to as the carriage moves across the rail. The leverage hook 134 is beveled at one end so that as the leverage sleeve 110 is reset, the hook disengages from the current opening 136 in the leverage rail 102 and can engage with the next opening 136. The leverage hook 134 is attached to the leverage sleeve end 108 by a half-inch retaining pin 140, which can be removed to adjust the direction of the leverage hook 134, allowing movement of the carriage 128 in the opposite direction. The leverage sleeve end 108 is attached to the leverage sleeve 110 which is hollow so a leverage sleeve or bar can be placed inside by the operator for added leverage. The leverage sleeve 110 is connected to the carriage 128 by an upright channel 112, connected to the axle supports 104, on either side of an axle 132. Two washers 106 are attached on both ends of the axle 132 to facilitate movement and to secure it to the axle supports 104. The axle supports 104 slots into the upright channels 112. The one or more anchor plates 124 and 126 of the carriage 128 are distanced far enough to not restrict the movement of the leverage sleeve end 108 and the leverage hook 134. The leverage hook 134 can be disengaged from the leverage rail 102 to allow for free movement of the carriage 128 along the rail when force does not need to be applied against another object or when the carriage 128 needs to be repositioned.

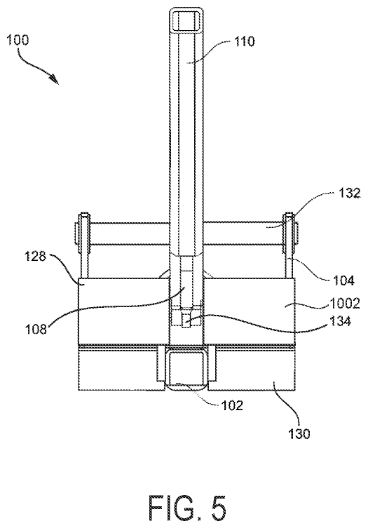

FIG. 5 depicts a rear view of the portable leverage apparatus 100, according to embodiments of the present invention. The leverage rail 102 runs underneath the carriage 128 with a side channel 130 on each side to keep the carriage aligned. The first support 124 sits at the front of the carriage 128 and has a semi-circle cutout to hold the head of a jackhammer. The clamp 120 sits behind the first support 124 and attaches to the second support 122, refer to FIG. 2 The axle supports 104 sit at the far end of the carriage 128 and connect to the axle 132, which is held in place by two washers 106 on each side. The axle 132 is threaded through and attached to the leverage sleeve 110 and the leverage sleeve end 108, which connects to the leverage hook 134 with a removable half-inch retaining pin 140. In at least one embodiment, the end plates 1002 are visible with an opening to allow the leverage sleeve 110, leverage sleeve end 108 and leverage hook 134 to pass through.

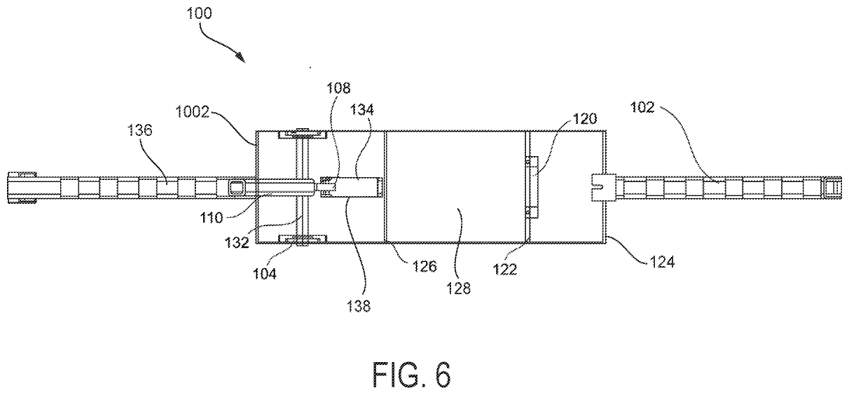

FIG. 6 depicts a top view of the ground piercing apparatus 100, according to embodiments of the present invention. The carriage 128 straddles the leverage rail 102, with the side channels 130 having beveled edges. The curved cutout of the first support 124 juts out slightly from the front of the carriage 128 to accommodate the head of a power tool. The clamp 120 for securing the neck of the jackhammer is visible above the sides of the carriage 128. At side back of the carriage 128, the axle supports 104, one on both ends of the axle 132, are visible and slotted into the upright channels 112 on the inside walls of the carriage 128. The axle 132 runs through the axle supports 104, the leverage sleeve 110 and the leverage sleeve end 108. The washers 106 ensure free movement of the axle 132 while keeping it centered and attached to the axle supports 104. At the end of the leverage sleeve 110 the leverage sleeve end 108 is inserted. The leverage hook 134 visible in FIG. 4, is attached to the leverage sleeve end 108 by a half-inch retaining pin. The leverage hook 134 engages with the leverage rail 102 through an opening 138 in the floor of the carriage 128 to propel the carriage forward or backward.

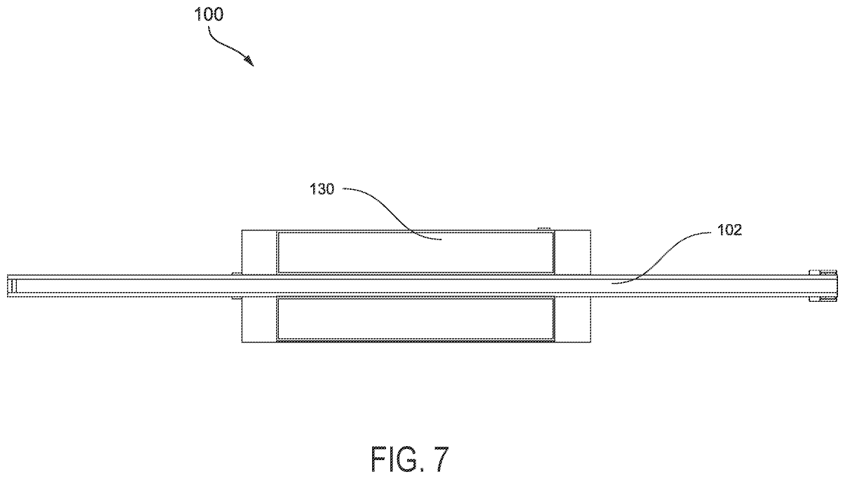

FIG. 7 depicts a right a bottom view of the ground piercing apparatus 100, according to embodiments of the present invention. The carriage 128 sits atop the leverage rail 102, with the side channels 130 having beveled edges. The curved cutout of the first support 124 juts out slightly from the front of the carriage 128 to accommodate the head of the power tool 116.

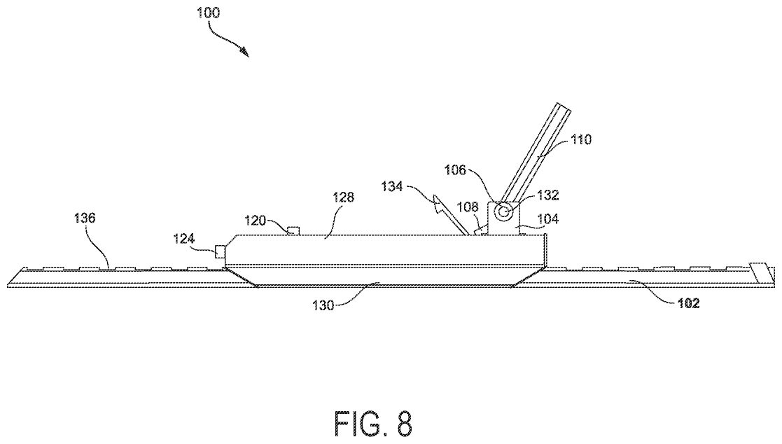

FIG. 8 depicts a left side view of the ground piercing apparatus 100 in a disassembled configuration, according to embodiments of the present invention. The leverage rail 102 contains multiple openings 136 along the top for the leverage hook 134 to engage with, as well as one hole in the bottom front and rear ends so a peg or stake can be inserted to secure the rail to the ground. The front is cut at an angle to provide easy access to this hole. The stake is driven into the ground on the front end of the leverage rail 102 so that the finished elevation of the top of the stake is below the finished elevation of the top of the rail. One more stake is driven through the rail at the rear so the rail is firmly secured in place. The body of the carriage 128 is formed with two side walls and a hole 138 cut out from the bottom near the back for the leverage hook 134 to descend through. Two side channels 130 are attached to the bottom of the carriage 128, one on each side. These are beveled at the front and rear to ensure that the carriage 128 can move over rough ground. The first support 124 has a semi-circle cutout at the top with an extended lip to hold the head of a power tool. On the inside of the lip is a small notch for holding extraction chains. The second support 122 also has a semi-circle cutout at the top and a screw hole on each side so it can connect with the clamp 120. The second support 122 also has a small hole on one side to fit a hex key. The clamp 120 is a semi-circle shape with attachment points on either end. When attached with screws to the second support 122 the clamp 1 holds the neck of a jackhammer in place. The support plate 126 is a solid sheet placed right before the hole in the carriage 128. The back plate 1002 of the carriage 128 is made of two separate plates with space so the leverage sleeve end 108 can fit between them.

Two axle supports 104 are inserted into the upright channels 112 on either side at the side back of the carriage 128 with a hole towards the top large enough to fit the axle 132. The axle 132 is affixed to the axle supports 104 with two washers 106 on each side to ensure the axle 132 is secured from lateral movement while retaining the ability to rotate. The leverage sleeve 110 is attached to the axle 132 and the top is kept open so a leverage bar can be inserted into the sleeve for added leverage. The leverage sleeve end 108 is inserted into the leverage sleeve 110 and is also attached to the axle 132. The bottom of the leverage sleeve end 108 contains a small hole for a retaining pin 140. The rear of the leverage hook 134 contains two circular loops, spaced apart so that the leverage sleeve end 108 can fit between them, where a retaining pin 140 is placed to connect the two parts. The front end of the leverage hook 134 curves down slightly before returning to the normal thickness. This bevel on the front of the leverage hook 134 allows it to deflect up out of the openings 136 of the leverage rail 102 as it collides with the front edge of the opening. Then as the leverage hook 134 slides over the top of the next section of rail to the next opening 136 and drops into the next opening 136, the back side of the bevel grabs the back edge of the next opening 136 with the back side of the beveled portion in order to create a ratcheting mechanism. When the leverage sleeve 110 is moved forward, the leverage hook 134 engages with one of the openings 136 in the leverage rail 102, moving the carriage 128 forward. When the leverage sleeve 110 is moved back, the leverage hook 134 disengages and slides forward over the leverage rail 102 to the next opening 136.

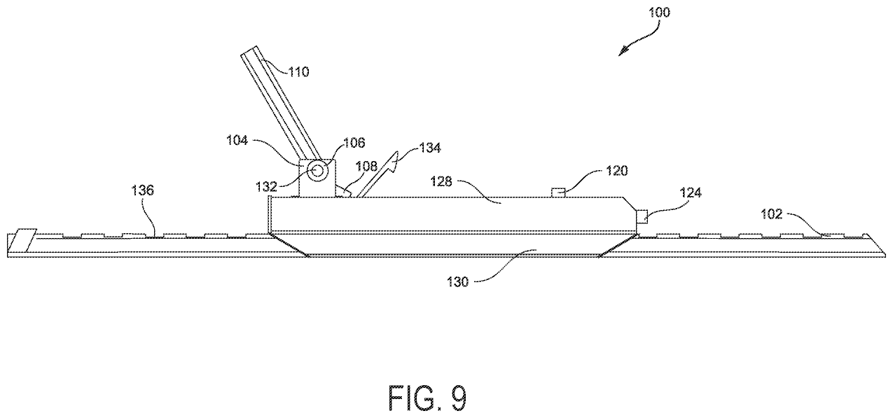

FIG. 9 depicts a right side view of the portable ground piercing apparatus 100 in an assembled configuration, according to another embodiment of the present invention. The leverage rail 102 has an opening in the front and rear ends so a peg or stake can be inserted to secure the leverage rail 102 to the ground. At the back, one additional opening is provided so that another peg or stake can be inserted to secure the rail 102 to the ground. The leverage rail 102 is secured to the ground on both ends. The body of the carriage 128 is formed with two side walls and a hole 138 cut out from the bottom near the back for the leverage hook 134 to descend through. A side channel 130 is attached to both sides of the bottom of the carriage 128. The side channels 130 are beveled at both ends to ensure that the carriage can move over uneven ground. The first support 124 has a semi-circle cutout at the top with an extended lip to hold the head of a jackhammer. At the back is a small notch for holding an extraction chain. The second support 122 also has a semi-circle cutout at the top and a screw hole on each side so it can connect with the clamp 120. The clamp 120 is a semi-circle shape with attachment points on either end. When screws are used to attach it to the second support 122, the clamp 120 holds the neck of a jackhammer in place. The support plate 126 is a solid sheet placed right before the hole 138 in the carriage 128. The back plate 1002 of the carriage 128 is made of two separate plates with space between them or 1 single plate with an opening so the leverage sleeve 110 and leverage hook 134 can pass through it.

In at least one embodiment, two axle supports 104 are inserted into the upright channels 112, as shown in FIG. 2 on both sides of the carriage 128 with a hole at the top large enough to fit the axle 132. The axle 132 is affixed to the axle supports 104 with two washers 106 on each side to ensure that the axle 132 retains the ability to rotate while remaining attached to the rest of the mechanism. The leverage sleeve end 108 is inserted into the leverage sleeve 110 and both are attached to the axle 132. The top of the leverage sleeve 110 is kept open so a leverage bar can be inserted into the sleeve for added leverage. The bottom of the leverage sleeve end 108 contains a small hole for a half-inch retaining pin 140. The rear of the leverage hook 134 contains two circular loops, spaced apart so that the leverage sleeve end 108 can fit between them, and the retaining pin 140 is placed to connect the two parts. The leverage hook is then able to pivot at this joint. The front end of the leverage hook 134 curves down slightly before returning to the normal thickness with a slight inwards curve to create a ratcheting mechanism. When the leverage sleeve 110 is moved forward, the leverage hook 134 drops into one of the openings 136 in the leverage rail 102, moving the carriage 128 forward. When the leverage sleeve 110 is moved back, the leverage hook 134 disengages the leverage rail 102 and slides forward over to the next opening 136.

According to another embodiment of the present invention, the apparatus 100 can be used to install materials through pre-existing straight horizontal holes. The leverage rail 102 and carriage 128 are placed in a trench at one end of the hole so that the curved cutout in the first support 124 is in alignment with the hole. The side channels 130 should sit on either side of the leverage rail 102 and are beveled on each end to allow for easy movement over rough ground. Once the desired position is achieved, the leverage rail 102 should be secured with stakes, one at the front in the hole at the base of the rail and one in the rear of the rail. Shafts or a ground piercing device are inserted or driven into the ground either manually or using the carriage as described above until they exit the other side of the pavement or obstacle and the hole is created. The material you wish to insert is attached to the shafts in the exit pit and an extraction chain is attached to the notch in the bottom of the first support 124 in the entrance trench. The chain is slotted into a notch at the base of the semi-circle cutout of the first support 124, which is attached to the carriage 128. At the rear of the carriage 128, upright channels 112 are placed on each side. The axle supports 104, which form part of the leverage mechanism, slot into the upright channels 112 and are bolted into place. An axle 132 is secured to the axle supports 104 by two washers 106 on each end. Attached to the axle 132 are the leverage sleeve 110 and the leverage sleeve end 108. The leverage sleeve end 108 is inserted into the bottom of the leverage sleeve 110 and the axle 132 intersects them both. The leverage sleeve is hollow so the operator can place a bar into it for added leverage. The base of the leverage sleeve end 108 contains a hole, where a half-inch retaining pin 140 is used to attach the leverage hook 134. In this embodiment, the leverage hook 134 should be attached in the reverse direction, facing the rear of the carriage 128. The magnets set inside the holes on each side of the leverage sleeve end 108 are used to hold the leverage hook 134 up clear from the leverage rail 102 when the carriage needs to be moved freely over the rail. When disengaged from the magnets, the leverage hook 134 then drops back down and is able to engages with the openings 136 in the top of the leverage rail 102 when force is applied to the leverage sleeve 110 pushing it towards the back of the carriage 128. This moves the entire carriage backward. When the end of the stroke is reached and the leverage sleeve 110 is moved back to its starting position, the curved end of the leverage hook 134 disengages itself from the leverage rail 102 and moves to engage the next opening 136. This process can be repeated until the end of the leverage rail 102 is reached. At that point, the shaft can be removed and the leverage hook 134 disengaged from the leverage rail 102 so the entire carriage 128 can be moved back to the beginning of the rail closest to the next shaft to be extracted. If the material (e.g. pipe or conduit) has not yet emerged then the extraction chain can be reattached to the next shaft and the entire process can be repeated until the material exits the hole and emerges into the entrance trench.

According to another embodiment of the present invention, the apparatus 100 can be used to remove pre-existing material, such as piping or wires, which has been run underneath existing structures, such as a driveway or sidewalk, without the need to remove or demolish the structure to access the material. Trenches dug on either side are used to disconnect the buried material from the rest of the underground system. On one side of the structure, the leverage rail 102 can be affixed to the ground with two stakes, one in the hole at the front of the rail and one in the rear of the rail. The carriage 128, can be placed atop the leverage rail 102. An extraction chain can be attached to the material and the end of the chain hooked into the notch in the base of the first support 124. The first support 124 is attached to the front of the carriage 128, which sits atop the leverage rail 102. Two side channels 130 are attached to the bottom of the carriage 128 and rest on either side of the leverage rail 102. The ends of the side channel 130 are beveled to ensure the carriage can slide over uneven ground; they also serve to keep the carriage on track and prevent it from shifting side to side while in use. A leverage bar can be placed by the operator into the top of the leverage sleeve 110 for added leverage. The leverage sleeve end 108 is inserted into the base of the leverage sleeve 110 and both are attached to an axle 132. The axle 132 has two washers 106 affixed to each end which attach the axle 132 to the axle supports 104. These uprights slot into two upright channels 112 and can be bolted in place. The upright channels 112 are permanently affixed to the carriage 128. At the base of the leverage sleeve end 108 is a hole that allows the leverage hook 134 to be attached by a half-inch retaining pin 140. In this embodiment, the leverage hook 134 is attached in the reverse position so it is facing the rear of the carriage 128. A hole 138 in the base of the carriage 128 allows the leverage hook 134 to engage with the openings 136 in the top of the leverage rail 102, and when the operator applies force by pushing back on the leverage sleeve 110 the entire carriage is moved backward, pulling the extraction chain and anything attached to it out of the ground. When the operator moves the leverage sleeve 110 back to start a new stroke the curved end of the leverage hook 134 will disengage itself from the leverage rail 102 and slide over the top to engage the next opening 138. This process is repeated until the end of the leverage rail 102 is reached. If the material is not fully extracted at this point then the extraction chain can be disconnected from the extracted shaft and the extraction chain reattached to the next section of shaft that is still under the ground. The carriage 128 can be manually moved back to the beginning of the leverage rail 102 by manually disengaging the leverage hook 134 from the rail and attaching it to the leverage sleeve end 108 and connecting it with the magnet or other attachment means (e.g., hook, latch, rubber or elastic band and Velcro), inserted into the sleeve end in order to secure the leverage hook 134 in a position disengaged from the leverage rail 102. The carriage will now move freely. Once at the beginning of the track, the extraction chain can be reinserted into the notch in the first support 124, and the entire process is repeated until the old material is fully extracted. New material can also be attached to the old material and can be pulled into the hole as the old material is extracted or the hole can be filled, if no longer necessary.

In another embodiment, the present invention can be operated without a leverage bar being inserted into the leverage sleeve 110. The leverage rail 102 is placed on the ground and secured using one stake placed in the hole at the front of the rail and one stake placed in the hole at the rear. The carriage 128 is placed on top of the leverage rail 102 with the side channels 130 on either side. The side channels 130 are beveled on each end so the carriage moves easily over uneven ground. A power tool 116 shown in FIG. 1, can be placed inside the carriage 128 in order to facilitate making a hole the head resting against the first support 124 and the neck secured to the second support 122 with the clamp 120 and two screws. The top of the jackhammer rests against the second support 120. Alternatively, an extraction chain can be placed in the notch at the rear of the semi-circle cutout in the first support 124 for extracting or installing materials. Two axle supports 104 attached to the carriage 128 hold the leverage mechanism when in use. The two axle supports 104 slot into the upright channels 112 and are bolted in place. The axle 132 is connected to the support plates 104 by two washers 106 on each side, which allows the axle 132 to rotate freely. The axle intersects the leverage bar sleeve 110 and the leverage sleeve end 108. The leverage sleeve end 108 is connected to the leverage hook 134 by a half-inch retaining pin 140. The retaining pin 140 allows the leverage hook 134 to be attached in either the forward or reverse direction allowing the carriage to operate both forwards and backward without repositioning the carriage 128. The leverage hook 134 engages with the openings 136 in the leverage rail 102 allowing the carriage 128 to be moved when force is applied by the operator to the leverage sleeve 110. The leverage produced by just the leverage sleeve 110 is not as great as that produced when a leverage bar is inserted but the invention is still operable. As the leverage sleeve 110 is reset, the beveled front of the leverage hook 134 will disengage itself from the opening 136 it is currently in and slide forward to engage with the next opening 136 in the leverage rail 102. Force can then be applied again to move the carriage further along the rail. Once the end of the rail is reached the leverage hook 134 can be disengaged from the leverage rail 102 and attached to the one or more magnets on the leverage sleeve end 108 or rested elsewhere so the carriage can be moved freely. Once in position the leverage hook 134 can be re-engaged so the process can be repeated for further ground piercing penetrating/piercing or extraction.

In yet another embodiment of the current invention, the apparatus includes a carriage that holds a power tool (e.g., jack hammer or other drilling/piercing apparatus) horizontal and in line with the ground piercing portion of the apparatus and also houses the leverage mechanism. The carriage is mobile and travels along the leverage rail in both directions. The carriage has one or more side channels and straddles the leverage rail, which keep the carriage aligned with the leverage rail in an undeviating and secure trajectory. The apparatus also includes a leverage rail which is stationary and separate from the carriage and provides incremental anchor points, or openings, against which leverage is created in the carriage to move it along the leverage rail in a linear motion. The leverage rail also serves as a guide to keep the carriage from veering left or right as it progresses in either direction. The leverage rail also provides a surface upon which the carriage can slide easily in either direction while maintaining a consistent elevation and it can be secured to the ground with known attachment mechanisms (e.g., steel stakes through the rail anchors).

In at least one embodiment, the apparatus also includes a leverage sleeve into which a leverage bar may be inserted to create leverage.

In at least one embodiment, the apparatus also includes a leverage hook, which connects the carriage to the leverage rail which serves as an stationary anchor point against which the carriage can be leveraged to move in a foreword or reverse direction.

In at least one embodiment, the leverage hook is connected to the part of the leverage mechanism known as the leverage sleeve end. The leverage sleeve end is connected to the opposite end of the leverage sleeve and is in line with the sleeve end.

In at least one embodiment, the leverage hook can drop into the opening of the leverage rail which is stationary and a separate piece from the carriage and provides an anchor point against which the carriage is leveraged by means of the leverage mechanism which consists of the axle, leverage sleeve that allows a leverage bar to be inserted, the leverage sleeve end and the leverage hook. As the leverage bar or sleeve is pushed or leveraged forward the carriage is simultaneously shoved forward with it since it is part of the apparatus.

In at least one embodiment, the axle which provides the fulcrum point within the leverage mechanism to create a substantial amount of leverage to shove the carriage forward, this axle allows the leverage bar and leverage sleeve, to be maneuvered back and forth. The backward movement of the leverage bar pivots on the upper part of the axle which it is attached to. As the axle pivots with the backward movement or rotation of the leverage bar which is attached to it then the sleeve end which is attached to the lower or opposite side of the axle is simultaneously shoved forward thus, advancing the leverage hook, which it is attached to, forward along the top of the leverage rail until it drops into an opening in the top of the leverage rail. Once the leverage hook anchors into the opening of the leverage rail then the leverage bar and sleeve is shoved forward, which in turn shoves the carriage with the apparatus forward, thus driving in the ground piercing apparatus which it is connected to, forward and through the ground that the user is trying to make a hole through.

In at least one aspect of an embodiment, the device also include any shape and size of holes that can receive a means of anchoring (e.g., bolts) that secures the clamp or support to the intended power tool (e.g., electric or pneumatic hammer, drill or driver).

In yet another embodiment, the leverage sleeve, the leverage sleeve end and the fulcrum point or axle are all welded together or assembled together in a fixed and secure manner.

In yet another embodiment, an apparatus used to create a hole through the ground is provided and the apparatus includes a carriage capable of receiving a tool that can make a hole through the ground, a leverage sleeve or bar connected to the carriage and one or more leverage rails having more than one opening.

In another aspect of at least one embodiment, the apparatus further comprises one or means of securing the carriage or the leverage sleeve or bar to the leverage rail. The means can be any know structure that allows the carriage or the leverage sleeve or bar to be temporarily secured to or engaged with carriage. Means of securing the carriage can be accomplished by any means known in the art, including but not limited to an axle, lever, hook, hinge or other known attachment means. FIG. 1 shows hook 134 as the means of securing the leverage sleeve and fulcrum point to the leverage rail. This allows the user of the apparatus to transfer the leverage forces created by the leverage mechanism to the power tool. In at least one embodiment, tool 116 drives the ground piercing apparatus to help create a hole through the ground. The connection means allows the user of the apparatus to engage and disengage the leverage sleeve or bar from the leverage sleeve repeatedly.

In another aspect of at least one embodiment, the one or more means is a leverage hook 134 that is attached to carriage or the leverage sleeve end as shown and described in FIG. 1.

In another aspect of at least one embodiment, the apparatus further comprises one or more clamps or supports on the carriage. Among other things, this allows the tool or power tool to be secured in place so that the apparatus functions most effectively.

In another aspect of at least one embodiment, the apparatus further comprises a connection means between the leverage sleeve or bar and leverage hook. In at least one embodiment, the connection means between the leverage sleeve or bar and the leverage hook is a pin or other fastener that hold the leverage sleeve or bar and leverage hook together.

In another aspect of at least one embodiment, the apparatus further comprises one or more magnets in connection with or in close proximity to the leverage hook. Among other things, the one or more magnets keep the leverage hook in the position that the user would like it to be in when it is not engaged with the leverage rail.

In another aspect of at least one embodiment, the apparatus further comprises one or more axle that is connected with the leverage sleeve 110 or and leverage sleeve end 108 to create a fulcrum point between the 2 parts 110 and 108. The one or more axle allows the leverage sleeve and/or bar to pivot and engage the connection means (e.g., hook) with the leverage rail.

In another aspect of at least one embodiment, the leverage hook comprises at least one hole.

In another aspect of at least one embodiment, the apparatus further comprises one or more plates connected to the carriage, which, among other things give the apparatus structure and support and define an area for the tool or power tool that will assist in making a hole through the ground.

In another aspect of at least one embodiment, the apparatus further comprises one or more side channels connected to the carriage.

In another aspect of at least one embodiment, the carriage has at least one hole in bottom of the carriage.

In another aspect of at least one embodiment, the apparatus further comprises one or more anchors which help temporarily attach the apparatus to the ground.

In another aspect of at least one embodiment, the one or more leverage rails include more than one hole that is configured to accept one or more anchors which temporarily attach the apparatus to the ground.

In another aspect of at least one embodiment, the apparatus comprises a carriage capable of receiving a tool or power tool and configured to travel at least backward and forward on a one or more leverage rails, a leverage sleeve or bar connected to the carriage and a leverage hook connecting the carriage to the rail and one or more leverage rails having more than one opening into which the leverage hook engages.

In another aspect of at least one embodiment, a method for making a hole through the ground is provided. The method comprises (1) attaching an apparatus having a carriage capable of receiving a tool that can make a hole through the ground, a leverage sleeve or bar connected to the carriage and one or more leverage rails having more than one opening to the ground, (2) securing a tool to the carriage that can make a hole through the ground and (3) pushing the leverage sleeve or bar forward to make a hole in the ground.

In another embodiment of the present invention disclosed herein, the apparatus has the capability of installing a construction object (such as a pipe or conduit) in a particular location by attaching the construction object to the carriage, moving the carriage, that includes a tool, with or without power, backward and pulling the construction object into a particular desired location.

While the invention has been described in connection with what is presently considered to be the most practical and various embodiments, it is to be understood that the invention is not to be limited to the disclosed embodiments, but on the contrary, is intended to cover various modifications and equivalent arrangements included within the spirit and scope of the appended claims.

This written description uses examples to disclose the invention, including the best mode, and also to enable any person skilled in the art to practice the invention, including making and using any apparatus or systems and performing any incorporated methods. The patentable scope of the invention is defined in the claims and may include other examples that occur to those skilled in the art. Such other examples are intended to be within the scope of the claims if they have structural elements that do not differ from the literal language of the claims, or if they include equivalent structural elements within substantial differences from the literal languages of the claims.

I/we claim:

1. An apparatus, the apparatus comprising:
a carriage capable of receiving a tool that can make a hole through the ground;
a leverage sleeve or bar connected to the carriage; and
one or more leverage rails having more than one opening.

2. The apparatus of claim 1, wherein the apparatus further comprises one or more means of securing the carriage or the leverage sleeve or bar to the leverage rail.

3. The apparatus of claim 2, wherein the one or more means is a leverage hook that attached to carriage or the leverage sleeve or bar.

4. The apparatus of claim 1, wherein the apparatus further comprises one or more clamps or supports on the carriage.

5. The apparatus of claim 3, wherein the apparatus further comprises a connection means between the leverage sleeve or bar and leverage hook.

6. The apparatus of claim 1, wherein the apparatus further comprises one or more magnets in connection with or in close proximity to the leverage hook.

7. The apparatus of claim 1, wherein the apparatus further comprises one or more axle that is connection with the leverage sleeve or bar

8. The apparatus of claim 3, wherein the leverage hook comprises at least one hole.

9. The apparatus of claim 1, wherein the apparatus further comprises one or more plates connected to the carriage.

10. The apparatus of claim 1, wherein the apparatus further comprises one or more side channels connected to the carriage.

11. The apparatus of claim 1, wherein the carriage has at least one hole in bottom of the carriage.

12. The apparatus of claim 1, wherein the apparatus further comprises one or more anchors.

13. The apparatus of claim 12, wherein the one or more leverage rails include more than one hole that is configured to accept one or more anchors.

14. An apparatus, the apparatus comprising:
a carriage capable of receiving a power tool and configured to travel at least backward and forward on a one or more leverage rails;
a leverage sleeve or bar connected to the carriage; and
one or more leverage rails having more than one opening.

15. The apparatus of claim 14, wherein the apparatus further comprises one or more means of securing the carriage or the leverage sleeve or bar to the leverage rail.

16. The apparatus as claimed in claim 15, wherein the one or more means is a leverage hook that attached to carriage or the leverage sleeve or bar.

17. The apparatus as claimed in claim 14, wherein the apparatus further comprises one or more clamps or supports on the carriage.

18. The apparatus as claimed in claim 17, wherein the apparatus further comprises a connection means between the leverage sleeve or bar and leverage hook.

19. The apparatus as claimed in claim 14, wherein the apparatus further comprises one or more magnets in connection with or in close proximity to the leverage hook.

20. A method for using an apparatus, the method comprising:
attaching an apparatus having a carriage capable of receiving a tool that can make a hole through the ground, a leverage sleeve or bar connected to the carriage and one or more leverage rails having more than one opening to the ground;
securing a tool to the carriage that can make a hole through the ground; and
pushing the leverage sleeve or bar forward to make a hole in the ground.
